(19) United States
(12) Patent Application Publication
(10) Pub. No.: US 2015/0162579 A1
(43) Pub. Date: Jun. 11, 2015

(54) BATTERY MODULE

(71) Applicant: SAMSUNG SDI CO., LTD., Yongin-si (KR)

(72) Inventors: Sang-IL YI, Yongin-si (KR); Woon-Seong BAEK, Yongin-si (KR); Se-Jin JI, Yongin-si (KR); Kwan-IL OH, Yongin-si (KR)

(21) Appl. No.: 14/558,957

(22) Filed: Dec. 3, 2014

(30) Foreign Application Priority Data
Dec. 5, 2013 (KR) 10-2013-0150450

(51) Int. Cl. H01M 2/10

(52) U.S. Cl. CPC H01M 2/1077; H01M 2220/20

(57) ABSTRACT

A battery module includes a connection tab to electrically connect a plurality of first battery cells and a plurality of second battery cells. The second battery cells are coupled to and/or located between the first battery cells, and are arranged in first and second groups. Terminal portions having a same polarity in the second battery cells of the first and second groups face in opposite directions.

### CROSS-REFERENCE TO RELATED APPLICATION

Korean Patent Application No. 10-2013-0150450, filed on Dec. 5, 2013, and entitled, “BATTERY MODULE,” is incorporated by reference herein in its entirety.

### BACKGROUND

1. Field

One or more embodiments descried herein relate to a battery.

2. Description of the Related Art

High-power battery modules that use a non-aqueous electrolyte with high energy density have been developed. These modules are large capacity modules formed by connecting a plurality of battery cells, in parallel or series, and are typically used to driving the motors of electric vehicles. A battery pack can be configured by electrically connecting a plurality of these battery modules to one another.

Studies have been conducted to improve the productivity of the battery modules, as well as their shape and aesthetic appearance. However, many of these attempts have jeopardized the safety and operation of the battery modules.

### SUMMARY

In accordance with one or more embodiments, a plurality of first battery cells; a plurality, a plurality of second battery cells between the first battery cells, the plurality of second battery cells being arranged in first and second groups; and a connection tab configured to electrically connect the first and second battery cells, wherein terminal portions having a same polarity in the second battery cells of the first and second groups face in opposite directions.

The first group may be connected in parallel to a (1-1)-th battery cell of the two first battery cells, and the second group may be connected in parallel to a (1-2)-th battery cell of the two first battery cells. The first sub-module may include the first group and the (1-1)-th battery cell, a second sub-module may include the second group and the (1-2)-th battery cell, and the first and second sub-modules may be connected in series to each other.

The battery module may include a plurality of the first sub-modules and a plurality of the second sub-modules connected in series. Also, two terminal portions of the first battery cell may face a same direction, two terminal portions of the second battery cell may face in opposite directions, and the two terminal portions of the second battery cell and the two terminal portions of the first battery cell may face in different directions. The two terminal portions of the first battery cell and the two terminal portions of the second battery cell may face directions that cross each other.

The connection tab may include a first connection tab configured to electrically connect terminal portions having a first polarity in the first group and the (1-1)-th battery cell; a second connection tab configured to electrically connect terminal portions having a second polarity opposite to the first polarity in the second group and the (1-2)-th battery cell; and a third connection tab configured to electrically connect terminal portions having the second polarity in the first group and the (1-1)-th battery cell and between terminal portions having the first polarity in the second group and the (1-2)-th battery cell.

The battery module may include a protective circuit module electrically connected to the first and second battery cells. Also, each of the first battery cells may be a prismatic cell, and each of the second battery cells may be a cylindrical cell.

The battery module may include a housing portion between the plurality of first battery cells, wherein the housing portion accommodates the second battery cells. The housing portion may include a plurality of through-holes, and each of the second battery cells may be accommodated in a respective one of the through-holes. Each of the through-holes may be formed to extend in a direction crossing an extraction direction of the terminal portions of the first battery cells.

The second battery cells may extend in a direction crossing an extraction direction of the terminal portions of the first battery cells. The first battery cells may output a higher power compared with the second battery cells. The second battery cells may have a higher capacity compared with the first battery cells. The first and second battery cells may have different shapes.

In accordance with anther embodiment, a battery module includes at least two first battery cells; second battery cells connected to the at least two first battery cells; and a connector to electrically connect the first and second battery cells, wherein the first battery cells output higher power than the second battery cells and wherein the second battery cells have a higher capacity than the first battery cells.

The second battery cells may be arranged in first and second groups, and terminal portions of the second battery cells may have a same polarity in the first group face in a direction opposite to terminal portions of the second battery cells in the second group. The second battery cells may be between the at least two battery cells. The first and second battery cells may be arranged in a 2S3P structure.

### BRIEF DESCRIPTION OF THE DRAWINGS

Features will become apparent to those of skill in the art by describing in detail exemplary embodiments with reference to the attached drawings in which:

FIG. 1 illustrates an embodiment of a battery module;

FIG. 2 illustrates an exploded view of the battery module;

FIG. 3 illustrates a right side view of a first sub-module;

FIG. 4 illustrates a right side view of a second sub-module;

FIG. 5 illustrates a left side view of the first and second sub-module;

FIG. 6 illustrates an example of an electrical connection relationship of the battery module in FIG. 1;

FIG. 7 illustrates another embodiment of a battery module; and

FIG. 8 illustrates an exploded view of the battery module in FIG. 7.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

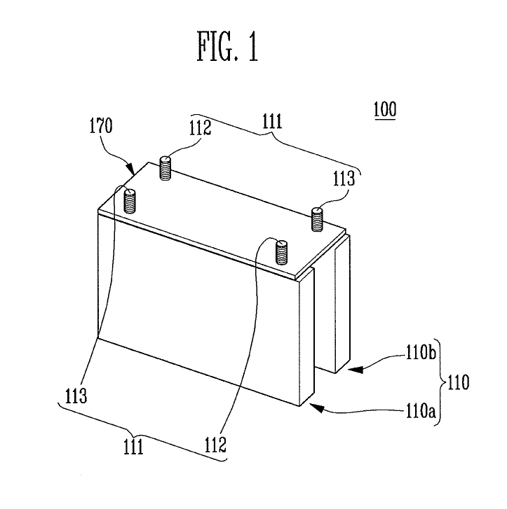

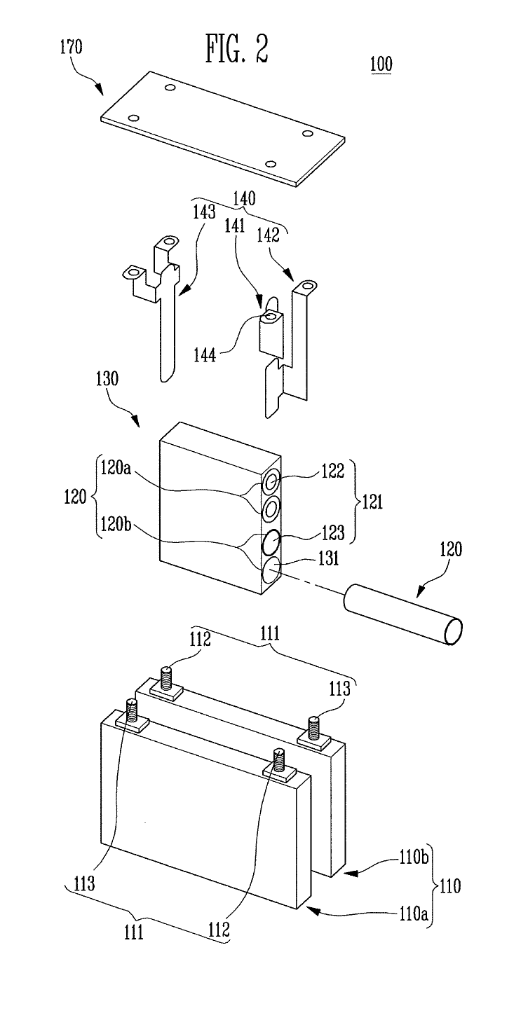

FIG. 1 illustrates one embodiment of a battery module 100, and FIG. 2 provides an exploded view of the battery module 100 in FIG. 1. As shown in FIGS. 1 and 2, battery module 100 includes a plurality of first battery cells 110, a plurality of second battery cells 120 positioned between the first battery cells 110, and a connection tab 140 for electrically connecting the first and second battery cells 110 and 120. The second battery cells 120 are divided into two groups. Second terminal portions 121 having the same polarities in the second battery cells 120 of the different groups may face opposite directions.

The first battery cells 110 may include a plurality of first battery cells (i.e., at least two first battery cells). The first battery cells may be disposed at respective sides of the second battery cells 120.

In one embodiment, the first battery cell 110 may be a prismatic cell from which first terminal portions 111 having first and second different polarities are extracted in the same direction. The first terminal portions may positioned in an erect form. In this case, each first battery cell 110 is a member which generates energy. Additionally, each first battery cell may include a battery case having an opened surface, and an electrode assembly and electrolyte accommodated in the battery case. The electrode assembly and the electrolyte may generate energy through an electrochemical reaction. The battery case may be sealed by one surface of the first battery cell 110, which may include, for example, a cap assembly.

The first terminal portions 111 having different polarities (i.e., a (1-1)-th terminal portion 112 having a first polarity and a (1-2)-th terminal portion 113 having a second polarity opposite to the first polarity) may be formed to protrude on the one surface of the first battery cell 110. The one surface of the first battery cell 110 may also include a vent portion as a safety feature of the first battery cell 110. The vent portion may serve as a passage through which gas generated inside the first battery cell 110 is exhausted from the first battery cell 110.

In one embodiment, each first battery cell 110 may output predetermined (e.g., higher) power as compared with the second battery cell 120. The higher power may be generated by a material capable of outputting high power as an electrode active material, or may be generated based on a method of controlling parameters including, for example, mixture density, thickness, and/or loading amount. This power may be generated even when using the same electrode active material used in the second battery cell 120. Thus, the first battery cell 110 may be considered to be a high-power battery. When the battery module 100 according to this embodiment is used for starting of a vehicle, in which an instantaneously high current is used, it is possible to improve low-temperature starting and high-power characteristics.

In on embodiment, a 2S3P structure may be formed as a basic structure. To form this structure, a case may include two first battery cells 110, e.g., a case in which a (1-1)-th battery cell 110a and a (1-2)-th battery cell 110b are included. The (1-1)-th battery cell 110a and the (1-2)-th battery cell 110b may be disposed so that the first and second polarities of the terminal portions 111 cross each other, relative to the connection tab 140. This arrangement may allow the length of the connection tab 140 to be as short as possible.

Like the first battery cell 110, the second battery cell 120 may generate energy, and may be positioned between the plurality of battery cells 110.

The second battery cell 120 may be, for example, a cylindrical cell different from the first battery cell 110. Second terminal portions 121 having different polarities in the second battery cells 120 may face opposite directions. In this case, the second battery cell 120 may be configured with a plurality of battery cells. Unlike the first battery cell 110, the second battery cell 120 may extend in a direction in which the second battery cell 120 is laterally laid. That is, the first terminal portion 111 of the first battery cell 110 may face an upper direction, and the second terminal portion 121 of the second battery cell 120 may face in a lateral direction perpendicular to the upper direction.

In this case, the second battery cells 120 may be arranged in parallel in the upper direction between the two first battery cells 110. A housing portion 130 between the first battery cells 110 may be provided to accommodate and maintain the arrangement of the second battery cells 120. A plurality of through-holes 131 may be formed in the housing portion 130. The through-holes 131 may extend in a direction perpendicular to the extraction direction of the first terminal portions 111 of the first battery cells 110. The second battery cells 120 may be inserted in respective ones of the through-holes 131. In another embodiment, the second battery cells 120 may be taped to maintain their arrangement without the housing portion 130.

The second battery cells 120 may include first and second groups 120a and 120b. For example, when four second battery cells 120 are disposed between the two first battery cells 110, each group may include two second battery cells. Hereinafter, the second battery cells 120 included in the first group 120a will be referred to as the first group 120a, and the second battery cells 120 included in the second group 120b will be referred to as the second group 120b.

The second terminal portions 121 of the first and second groups 120a and 120b may face different directions. That is, a (2-1)-th terminal portion 122 having the first polarity in the first group 120a may face a first direction and a (2-1)-th terminal portion having the first polarity in the second group 120b may face a second direction opposite to the first direction. In addition, a (2-2)-th terminal portion 123 having the second polarity in the first group 120a may face the second direction and a (2-2)-th terminal portion 123 having the second polarity in the second group 120b may face the first direction.

The second battery cell 120 may have a higher capacity compared to the first battery cell 110. In this embodiment, the battery module 100 has a 2S3P structure. The term “high capacity” may refer to the case where one second battery cell 120 has high capacity compared to one first battery cell 110, or to the case where a sum of the capacities of the second battery cells 120 arranged in a parallel structure is higher than the capacity of one first battery cell 110.

In one embodiment, the second battery cell 120 may be considered to have a high capacity. Hence, although the first battery cell 110 may output high power, the capacity and self-discharge characteristics of the first battery cell 110 may be relatively lowered. That is, a high-power battery and a high-capacity battery are connected to each other, thereby making up for their respective disadvantages.

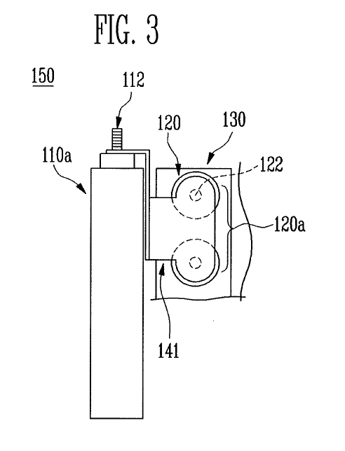

The connection tab 140 may electrically connect the first and second battery cells 110 and 120. In one embodiment, a serial/parallel connection between the first and second battery cells 110 and 120 may be established by the connection tab 140. The connection tab 140 may include a first connection tab 141, a second connection tab 142 and a third connection tab 143. Hereinafter, the electrical connection relationship between the first and second battery cells 110 and 120 according to the connection tab 140 will be described in detail with reference to FIGS. 3 to 6.

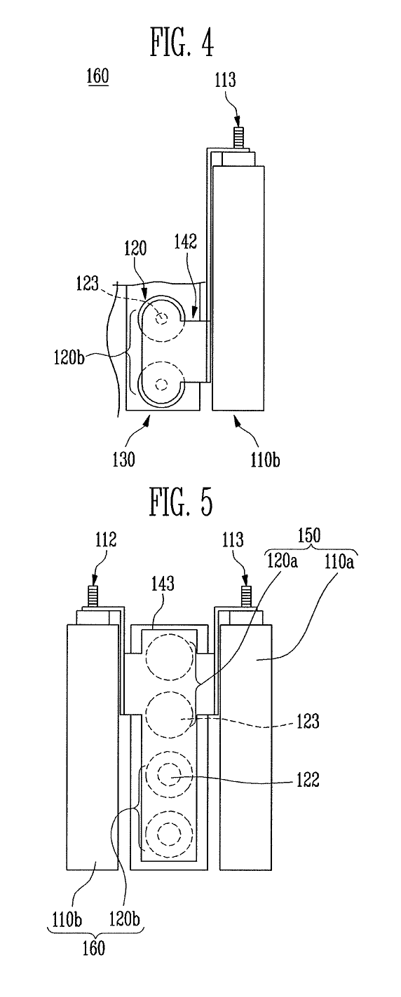

The battery module 100 according to this embodiment may have the 2S3P structure as described above. For convenience of illustration, two structures each in which one first battery cell 110 and two second battery cells 120 in one group are connected in parallel will be respectively referred to as first and second sub-modules 150 and 160. FIG. 3 illustrates a parallel connection relationship of the first sub-module 150, FIG. 4 illustrates a parallel connection relationship of the second of the second sub-module 160, and FIG. 5 illustrates a serial connection relationship between the first and second sub-modules 150 and 160.

FIG. 3 provides a right side view of a first sub-module 150 of the battery module 100 in FIG. 1. In this view, the first sub-module has a parallel connection relationship. As shown in FIG. 3, the first connection tab 141 may electrically connect the (2-1)-th terminal portions 122 having the first polarity in the first group 120a and the (1-1)-th terminal portion 112 having the first polarity in the (1-1)-th battery cell 110a. Thus, the first connection tab 141 electrically connects the (2-1)-th terminal portions 122 of the first group 120a and the (1-1)-th terminal portion 112 of the (1-1)-th battery cell 110a, which have the same polarity as the first polarity. As a result, the first group 120a and the (1-1)-th battery cell 110a are connected in parallel, thereby constituting the first sub-module 150.

The first connection tab 141 may have a bent shape to contact both the (2-1)-th and (1-1)-th terminal portions 122 and 112, which extend in directions perpendicular to each other. The connection tab 141 may also have a connection hole 144 through which the first terminal portion 111 of the prismatic (1-1)-th battery cell 110a passes, to be connected to the connection tab 140 (see FIG. 2).

FIG. 4 provides a right side view of a second sub-module 160 of the battery module 100. In this view, the second sub-module 160 has a parallel connection relationship. As shown in FIG. 4, the second connection tab 142 may electrically connect the (2-2)-th terminal portions 123 having the second polarity in the second group 120b and the (1-2)-th terminal portion 113 having the second polarity in the (1-2)-th battery cell 110b. Thus, the second connection tab 142 electrically connects the (2-2)-th terminal portions 123 of the second group 120b and the (1-2)-th terminal portion 113 of the (1-2)-th battery cell 110b, which have the same polarity as the second polarity. As a result, the second group 120b and the (1-2)-th battery cell 110b can be connected in parallel, thereby constituting the second sub-module 160.

In this case, the second terminal portions 121 of the first and second groups 120a and 120b face in different directions. Hence the first connection tab 141 connecting the terminal portions having the first polarity to each other and the second connection tab 142 connecting the terminal portions having the second polarity to each other can be positioned in the same direction (see FIG. 2). The second group 120b is positioned relatively lower, e.g., more distant from the first terminal portion 111 of the first battery cell 110 than the first group 120a. As a result, the length of the second connection tab 142 can be longer than that of the first connection tab 141. The second connection tab 142 may also have a connection hole through which the first terminal portion 111 of the (1-2)-th battery cell 110b passes. The second connection tab 142 may also have a bent shape.

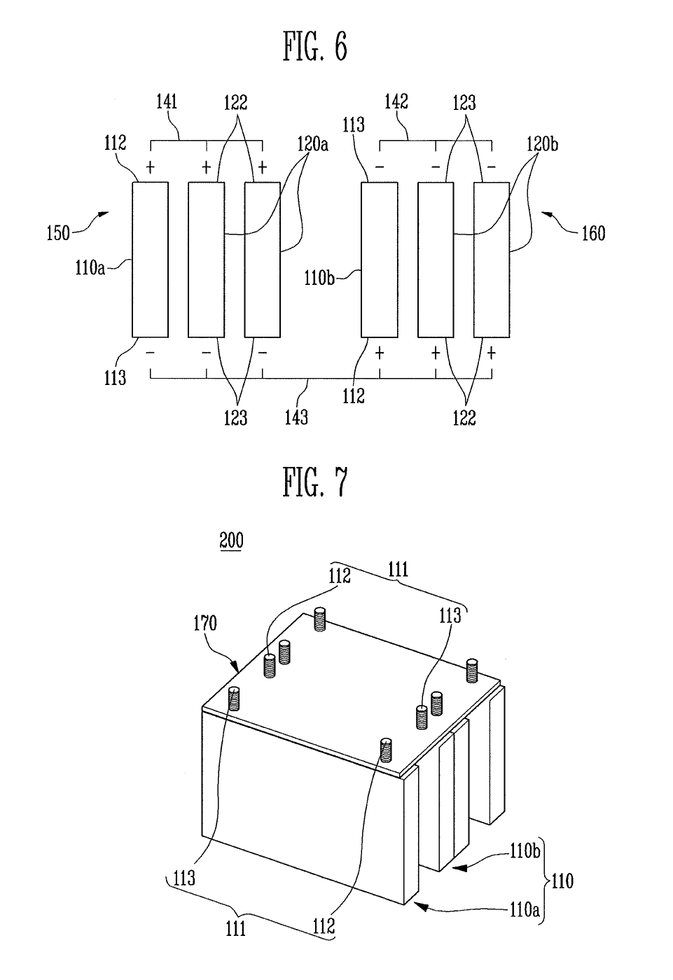

FIG. 5 provides a left side view of the first and second sub-modules 150 and 160. This view shows that a serial connection relationship exists between the first and second sub-modules 150 and 160. FIG. 6 illustrates an example of an electrical connection relationship among the first battery cell 110, second battery cell 120, and connection tab 140. For illustrative purposes, the first and second polarities are expressed as positive and negative polarities, respectively. However, the first and second polarities may be expressed as negative and positive polarities, respectively, in another embodiment.

Also, battery module 100 may have a 2S3P structure as described above. For illustrative purposes, each of two structures in which one first battery cell 110 and two second battery cells 120 in one group are connected in parallel will be respectively referred to as first and second sub-modules 150 and 160.

As shown in FIG. 5, the third connection tab 143 may be positioned at the opposite side of the first and second connection tabs 141 and 142. In this position, the third connection tab 143 may connect the first sub-module 150 configured by the first connection tab 141 and the second sub-module 160 configured by the second connection tab 142 in series to each other.

For example, as shown in FIGS. 5 and 6, the third connection tab 143 may connect all of the following: (2-2)-th terminal portion 123 having the second polarity in the first group 120a, the (1-2)-th terminal portion 113 having the second polarity in the (1-1)-th battery cell 110a, the (2-1)-th terminal portion 122 having the first polarity in the second group 120b, and the (1-1)-th terminal portion 112 having the first polarity in the (1-2)-th battery cell 110b, which are not in contact with the first and second connection tabs 141 and 142.

Accordingly, the second polarity of the first sub-module 150 and the first polarity of the second sub-module 160 are connected to each other. In this arrangement, the serial connection relationship between the first and second sub-modules 150 and 160 can be established. (In FIG. 6, the first and second polarities are expressed as positive and negative polarities, but this may be reversed).

As a result, high-current terminals of the battery module 100 may correspond to the first connection tab 141 having the first polarity or the (1-1)-th terminal portion 112 (shown in FIG. 3) of the (1-1)-th battery cell 110a and the second connection tab 142 having the second polarity or the (1-2)-th terminal portion 113 (shown in FIG. 4) of the (1-2)-th battery cell 110b. In this case, the third connection tab 143 connects a larger number of terminals, as compared with the first and second connection tabs 141 and 142. Hence, the third connection tab 143 may be formed relatively wide. Also, the third connection tab 143 may have a connection hole through which the first terminal portion 111 of the first battery cell 110 passes.

In this case, the length of the connection tab 140 may be decreased due to the disposition of the first and second battery cells 110 and 120. Thus, it is possible to reduce impedance, which may change (e.g., increase) as the length of the connection tab 140 changes (e.g., increases). Accordingly, it is possible to decrease the likelihood of a voltage drop from occurring. As a result, at least one embodiment of battery module 100 may be suitable for use as a starting device of a vehicle, which uses an instantaneously high current.

In one embodiment, the battery module 100 may include a protective circuit module 170 electrically connected to the first and second battery cells 110 and 120. The protective circuit module 170 may be positioned above the first battery cell 110 in the extending direction of the first terminal 111 of the first battery cell 110. The protective circuit module 170 may be electrically connected to not only the first battery cell 110, but also the second battery cell 120. This may be accomplished as a result of a connection of the first connection tab 141 to the (1-1)-th terminal portion 112 of the (1-1)-th battery cell 110a, connection of the second connection tab 142 to the (1-2)-th terminal portion 113 of the (1-2)-th battery cell 110b, and connection of the third connection tab 143 to the (1-2)-th terminal portion 113 of the (1-1)-th battery cell 110a and the (1-1)-th terminal portion 112 of the (1-2)-th battery cell 110b.

In one embodiment, the protective circuit module 170 may include or be coupled to a circuit board having a circuit pattern formed thereon. Several electronic components may be mounted on at least one surface of the protective circuit module 170. The electronic components may include, for example, a number of field effect transistors and/or integrated circuits. The electronic components may perform functions which include, for example, controlling the electrode assembly in each of the first and second battery cells 110 and 120 and/or cutting off a circuit when the electrode assembly is abnormally operated.

The circuit board of the protective circuit module 170 may also include a switching circuit. By cooperating with the electronic components, the switching circuit may more efficiently control or protect the battery module. In one embodiment, the switching circuit may prevent the battery module from exploding, overheating, leaking, and/or deterioration of charging/discharging characteristics of the battery module 100. The switching circuit may accomplish this, for example, by blocking overcharging, over discharging, overcurrent, short circuit, and/or reverse voltage of the battery module 100. In addition, the switching circuit may prevent lowering of electrical performance and/or abnormal operation of the battery module, to thereby eliminate dangerous factors and to extend the lifespan of the battery module 100.

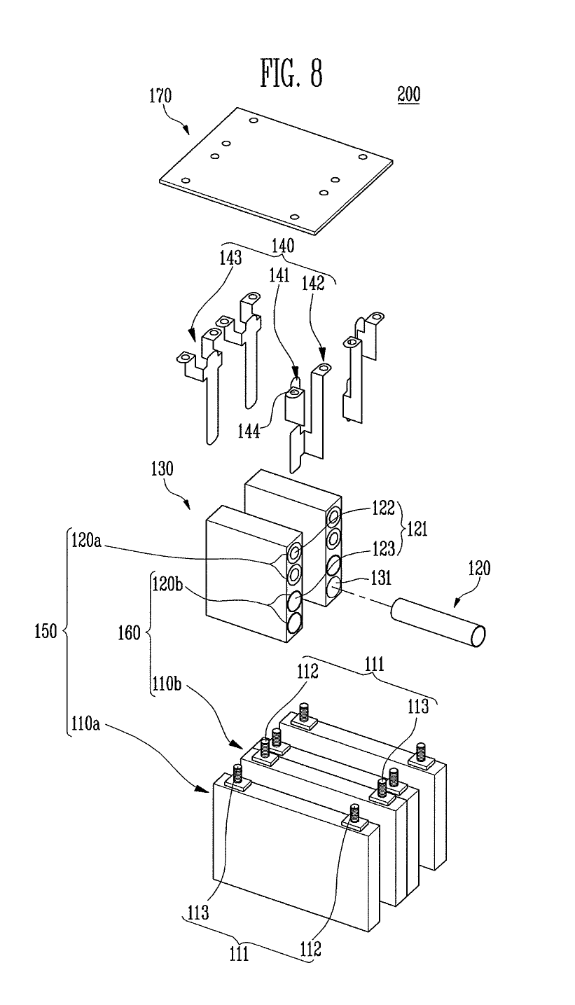

FIG. 7 illustrates another embodiment of a battery module 200, and FIG. 8 provides an exploded view of the battery module in FIG. 7. In this embodiment, battery module 200 has a 4S3P structure, formed by connecting two 2S3P structures, for example, in accordance with the first embodiment.

In the second embodiment, two first sub-modules 150 and two second sub-modules 160 may be included. The first and second sub-modules 150 and 160 may be electrically connected to one protective circuit module 170. As a result, the first sub-module 150 (implemented through a parallel connection) and the second sub-module 160 (implemented through a parallel connection) are connected in series, to thereby achieve the 4S3P structure.

In FIGS. 7 and 8, one first sub-module 150 and one second sub-module 160 are connected in series by one third connection tab 143, another first sub-module 150 and another second sub-module 160 are connected in series by another third connection tab 143, and assemblies of the first and second sub-modules 150 and 160 are connected in series in the protective circuit module 170. In other embodiments, the two first sub-modules 150 and the two second sub-modules 160 may be connected in series at a time, for example, by implementing the third connection tab 143 as one wide plate.

Also, in alternative embodiments, the numbers of the first and second sub-modules 150 and 160 may be increased, to thereby implement, for example, 6S3P, 8S3P or more structures. Additionally, or alternatively, the numbers of the first and second battery cells 110 and 120 in one sub-module 150 or 160 may be increased, to thereby implement 2SrP, 2S5P, or the like. In addition, the numbers of serial and parallel connections may be increased, to thereby implement 4S4P, 6S5P or the like.

By way of summation and review, embodiments provide a battery module which can be used as a high-power and high-capacity battery module by connecting a plurality of battery cells in parallel or series, e.g., a high-power battery and a high-capacity battery may be connected to each other, thereby making up for their disadvantages. For example, one or more embodiments may provide a battery module in which the battery cells are connected in series and parallel using a connection tab, thereby implementing the high power and high capacity of the battery module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of first battery cells;
a plurality of second battery cells between the first battery cells, the plurality of second battery cells being arranged in first and second groups; and
a connection tab configured to electrically connect the first and second battery cells, wherein terminal portions having a same polarity in the second battery cells of the first and second groups face in opposite directions.

2. The battery module as claimed in claim 1, wherein:
the first group is connected in parallel to a (1-1)-th battery cell of the two first battery cells, and
the second group is connected in parallel to a (1-2)-th battery cell of the two first battery cells.

3. The battery module as claimed in claim 2, wherein:
a first sub-module includes the first group and the (1-1)-th battery cell, a second sub-module includes the second group and the (1-2)-th battery cell, and wherein the first and second sub-modules are connected in series to each other.

4. The battery module as claimed in claim 3, further comprising:
a plurality of the first sub-modules and a plurality of the second sub-modules connected in series.

5. The battery module as claimed in claim 1, wherein:
two terminal portions of the first battery cell face in a same direction,
two terminal portions of the second battery cell face in opposite directions, and
the two terminal portions of the second battery cell and the two terminal portions of the first battery cell face in different directions.

6. The battery module as claimed in claim 5, wherein the two terminal portions of the first battery cell and the two terminal portions of the second battery cell face directions that cross each other.

7. The battery module as claimed in claim 2, wherein the connection tab includes:
a first connection tab configured to electrically connect terminal portions having a first polarity in the first group and the (1-1)-th battery cell;
a second connection tab configured to electrically connect terminal portions having a second polarity opposite to the first polarity in the second group and the (1-2)-th battery cell; and
a third connection tab configured to electrically connect terminal portions having the second polarity in the first group and the (1-1)-th battery cell and between terminal portions having the first polarity in the second group and the (1-2)-th battery cell.

8. The battery module as claimed in claim 1, further comprising a protective circuit module electrically connected to the first and second battery cells.

9. The battery module as claimed in claim 1, wherein:
each of the first battery cells is a prismatic cell, and
each of the second battery cells is a cylindrical cell.

10. The battery module as claimed in claim 1, further comprising:
a housing portion between the plurality of first battery cells,
wherein the housing portion accommodates the second battery cells.

11. The battery module as claimed in claim 10, wherein:
the housing portion includes a plurality of through-holes, and
each of the second battery cells is accommodated in a respective one of the through-holes.

12. The battery module as claimed in claim 11, wherein each of the through-holes is formed to extend in a direction crossing an extraction direction of the terminal portions of the first battery cells.

13. The battery module as claimed in claim 1, wherein the second battery cells extend in a direction crossing an extraction direction of the terminal portions of the first battery cells.

14. The battery module as claimed in claim 1, wherein the first battery cells output a higher power compared with the second battery cells.

15. The battery module as claimed in claim 1, wherein the second battery cells have a higher capacity compared with the first battery cells.

16. The battery module as claimed in claim 1, wherein the first and second battery cells have different shapes.
